(19) United States
(12) Patent Application Publication
(10) Pub. No.: US 2016/0005023 A1
(43) Pub. Date: Jan. 7, 2016

(54) CONDUCTING FINANCIAL TRANSACTIONS BY TELEPHONE

(71) Applicant: GOOGLE INC., Mountain View, CA (US)

(72) Inventors: Varun Soundararajan, Sunnyvale, CA (US); Anshul Kothari, Sunnyvale, CA (US); Gaurav Bhaya, Sunnyvale, CA (US); Anurag Agrawal, Palo Alto, CA (US)

(21) Appl. No.: 14/325,299

(22) Filed: Jul. 7, 2014

(51) Int. Cl. G06Q 20/30

(52) U.S. Cl. CPC G06Q 20/305

(57) ABSTRACT

A method for completing financial transactions by telephone comprises a user that indicates a desire to conduct a financial transaction with a merchant using financial account information maintained by an account system. The merchant determines the user's telephone number and prepares a request to the account system for data to complete the financial transaction. The account system prepares a request for authorization to transmit the data to the merchant to complete the financial transaction and transmits the request to a user device. The user device displays the request for authorization, and the user's authorization is transmitted to the account system. Upon receipt of the authorization, the account system account management system prepares limited use financial account for the transaction with the user and transmits the data to the merchant. The merchant completes the financial transaction requested by the user during the telephone call using the received data.

### TECHNICAL FIELD

The present disclosure relates generally to a conducting a financial transaction, and more particularly to methods and systems that allow users to conduct a financial transaction via a telephone.

### BACKGROUND

In a conventional merchant-consumer financial transaction, the user provides actual debit or credit card account information to the merchant by way of swiping the actual card, entering the actual card account number, scanning a code comprising the actual card account number, reading the actual card number to the merchant, or otherwise transmitting the actual card account number to a merchant system. The merchant system's point of sale terminal or online payment process engine submits a payment request to the issuer of the account through the corresponding card network. If funds are available, the issuer sends an authorization code to the merchant system to signal approval of the payment transaction.

During an over-the-telephone financial transaction, the user provides the actual card number and user details to the merchant by reading or reciting the information to the merchant. The merchant must write down or enter the details correctly to ensure the merchant system's point of sale terminal or online payment process engine can accurately submit the payment request to the issuer of the account. If the user makes an error in reciting the card number or user details, or if the merchant makes an error in entering the information, the payment request cannot be approved.

### SUMMARY

In certain example aspects described herein, a method for completing financial transactions by telephone comprises a user that initiates a telephone communication with a merchant and indicates a desire to conduct a financial transaction with the merchant using financial account information maintained by an account management system. The merchant determines the telephone number or other form of user device identification, and prepares a request to the account management system for additional data to complete the financial transaction. The account management system receives the request for data to complete the financial transaction, determines which user account is associated with the telephone number submitted on the request for data, determines what user information or data is requested, and determines whether the user allows the account management system to provide the requested data to a merchant. The account management system prepares a request for authorization to transmit the data to the merchant to complete the financial transaction, and transmits the request to a user device. In an example embodiment, the account management system's request for authorization comprises a notification that the merchant has requested additional data that the user has not previously provided or permitted to be shared, and allows the user to provide or authorize the additional data.

The user device displays the request for authorization, and the user's authorization is transmitted to the account management system. Upon receipt of the authorization, the account management system transmits the authorized data to the merchant. In an example embodiment, the account management system prepares a single or limited use financial account for the transaction with the user. In this embodiment, the financial account information is limited in amount, time, location, merchant type, merchant name, and/or other variable as it relates to the financial transaction. The merchant completes the financial transaction requested by the user during the telephone call using the data received from the account management system.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting an over-the-telephone payment system, in accordance with certain example embodiments.

FIG. 2 is a block flow diagram depicting a method for conducting a financial transaction via a telephone connection, in accordance with certain example embodiments.

FIG. 3 is a block flow diagram depicting a method for requesting data to complete a financial transaction from an account management system, in accordance with certain example embodiments.

FIG. 4 is a block flow diagram depicting a method for requesting user authorization to provide the requested financial data to the merchant to complete the financial transaction, in accordance with certain example embodiments.

FIG. 5 is a block diagram depicting a computer machine and module, in accordance with certain example embodiments.

### DETAILED DESCRIPTION OF THE EXAMPLE EMBODIMENTS

### Overview

The example embodiments described herein provide computer-implemented techniques for conducting financial transactions by telephone. In an example embodiment, a user registers with an account management system and provides financial account information (for example financial account number, expiration date, security code, and billing address), user information (for example, name and mailing address), and a user device identifier (for example, a telephone number, electronic mail address, internet protocol address, fax number, or other unique identifier) to the account management system. In an example embodiment, the user's financial account information and user device identifier are maintained in an account management system user account. In an example embodiment, the user selects preferences or rules that determine which information the account management system may provide to a merchant. The user enables a payment application or payment feature on the user's communication device that allows the device to communicate with the account management system.

The user initiates a telephone communication with a merchant and indicates a desire to conduct a financial transaction with the merchant using financial account information maintained by the account management system. The merchant determines the telephone number or other form of user device identification and prepares a request to the account management system for additional data to complete the financial transaction. In an example embodiment, the request comprises the user's telephone number, a request for financial information (for example, a financial account number, expiration data, security code, or other financial information needed to process a financial transaction), and a request for user information (for example, delivery address, billing address, name, or other user information). In an example embodiment, the merchant completes an online form or submission to request the data from the account management system (for example, by selecting fields of requested data and transmitting the selected fields to the account management system).

The account management system receives the request for data to complete the financial transaction and determines which user account is associated with the telephone number submitted on the request for data. The account management system determines what user information or data is requested and whether the user allows the account management system to provide the requested data to a merchant. The account management system prepares a request for authorization to transmit the data to the merchant to complete the financial transaction. In an example embodiment, the account management system's request for authorization comprises a notification that the merchant has requested additional data that the user has not previously provided or permitted to be shared, and allows the user to provide or authorize the additional data. The account management system transmits the request for authorization to a user device. In an example embodiment, the user device comprises the telephone used to call the merchant. In another example embodiment, the user device comprises a default user device designated by the user, or multiple user devices associated with the user's account.

The user device displays the request for authorization, and the user's authorization is transmitted to the account management system. Upon receipt of the authorization, the account management system transmits the authorized data to the merchant. In an example embodiment, the account management system prepares a single or limited use financial account for the transaction with the user. In this embodiment, the financial account information is limited in amount, time, location, merchant type, merchant name, and/or other variable as it relates to the financial transaction. The merchant completes the financial transaction requested by the user during the telephone call using the data received from the account management system.

Various example embodiments will be explained in more detail in the following description, read in conjunction with the figures illustrating the program flow.

### Example System Architectures

Turning now to the drawings, in which like numerals indicate like (but not necessarily identical) elements throughout the figures, example embodiments are described in detail.

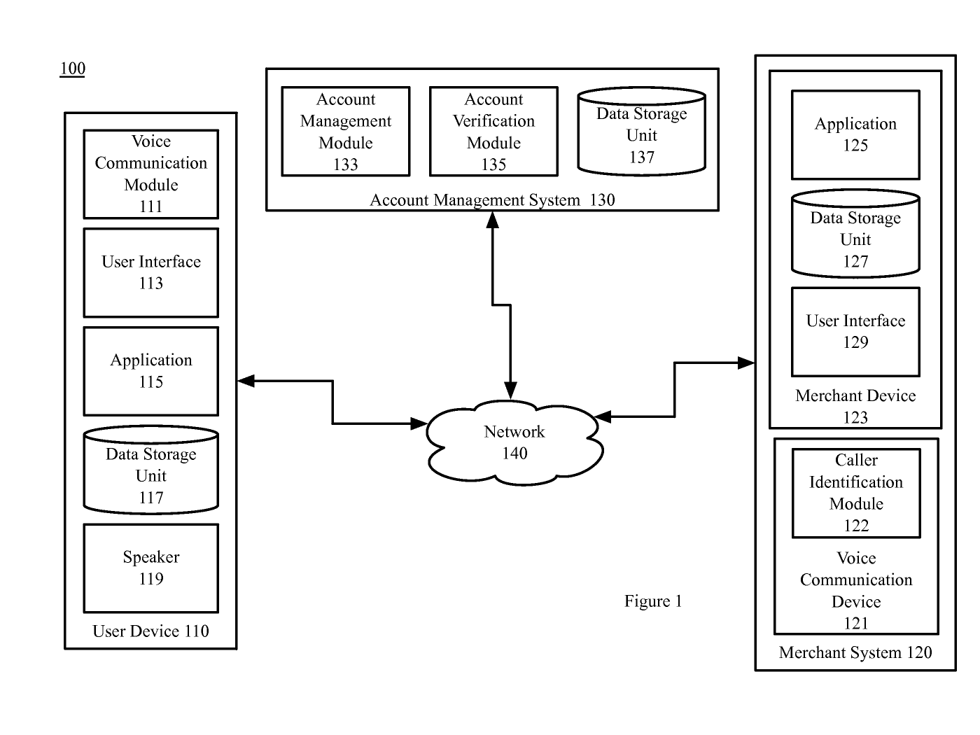

FIG. 1 is a block diagram depicting an over-the-telephone payment system 100, in accordance with certain example embodiments. As depicted in FIG. 1, the exemplary operating environment 100 comprises a user device 110, merchant system 120, and an account management system 130 that are configured to communicate with one another via one or more networks 140. In another example embodiment, two or more of these systems (including systems 110, 120, and 130) are integrated into the same system. In some embodiments, a user associated with a device (including device 110) must install an application and/or make a feature selection to obtain the benefits of the techniques described herein.

Each network 140 includes a wired or wireless telecommunication means by which network systems (including systems 110, 120, and 130) can communicate and exchange data. For example, each network 140 can be implemented as, or may be a part of, a storage area network (SAN), personal area network (PAN), a metropolitan area network (MAN), a local area network (LAN), a wide area network (WAN), a wireless local area network (WLAN), a virtual private network (VPN), an intranet, an Internet, a telephone network, a mobile telephone network, a card network, Bluetooth, Bluetooth Low Energy (BLE), near field communication network (NFC), any form of standardized radio frequency, infrared, sound (for example, audible sounds, melodies, and ultrasound), other short range communication channel, or any combination thereof, or any other appropriate architecture or system that facilitates the communication of signals, data, and/or messages (generally referred to as data). Throughout this specification, it should be understood that the terms “data” and “information” are used interchangeably herein to refer to text, images, audio, video, or any other form of information that can exist in a computer-based environment.

In an example embodiment, each network system (including systems 110, 120, and 130) includes a device having a communication module capable of transmitting and receiving data over the network 140. For example, each network system (including systems 110, 120, and 130) may comprise a server, personal computer, mobile device (for example, notebook computer, tablet computer, netbook computer, personal digital assistant (PDA), video game device, GPS locator device, cellular telephone, Smartphone, or other mobile device), a television with one or more processors embedded therein and/or coupled thereto, or other appropriate technology that includes or is coupled to a web browser or other application for communicating via the network 140. In the example embodiment depicted in FIG. 1, the network systems (including systems 110, 120, and 130) are operated by merchants, users, and an account management system operator, respectively.

In an example embodiment, the user device 110 may be a personal computer, mobile device (for example, notebook, computer, tablet computer, netbook computer, personal digital assistant (PDA), video game device, GPS locator device, cellular telephone, Smartphone or other mobile device), television, wearable computing devices (for example, watches, rings, or glasses), or other appropriate technology that includes or is coupled to a voice communication module 111 or other suitable application/technology for talking via a telephone network 140 to the merchant system 120 voice communication device 121 and a web server, or other suitable application 115 for interacting with the account management system 130.

The user can use the user device 110 to interact with the account management system 130 via a user interface 113 and an application 115. The application 115 is a program, function, routine, applet or similar entity that exists on and performs its operations on the user device 110. For example, the application 115 may be one or more of a shopping application, account management system 130 application, an Internet browser, a digital wallet application, a loyalty card application, another value-added application, a user interface 113 application, or other suitable application operating on the user device 110. In some embodiments, a user must install an application 115 and/or make a feature selection on the user device 110 to obtain the benefits of the techniques described herein.

In an example embodiment, the user registers with the account management system 130 and provides information for one or more financial accounts (for example, the user's name, billing address, mailing address, the financial account number, the financial account expiration date, the financial account security code, the user's phone number, the user's electronic mail (e-mail) address, merchant loyalty account information, and other information that may be required or requested to complete a financial transaction). In an example embodiment, the user uses the application 115 to provide this information to the account management system 130. In an example embodiment, the account management system 130 provides the user with an account identifier that is stored in the data storage unit 117. In another example embodiment, the information provided to the account management system 130 is also stored on the data storage unit 117. In an example embodiment, the data storage unit 117 and application 115 may be implemented in a secure element or other secure memory (not shown) on the user device 110. In another example embodiment, the data storage unit 117 may be a separate memory unit resident on the user device 110. An example data storage unit 117 enables storage of user contact details for retrieval of a user account management system 130 account. In an example embodiment, the data storage unit 117 can include any local or remote data storage structure accessible to the user device 110 suitable for storing information. In an example embodiment, the data storage unit 117 stores encrypted information, such as HTML5 local storage.

In an example embodiment, the user can use the user device 110 to interact with the merchant system 120 using a voice communication module 111 and a speaker 119. In an example embodiment, the user device 110 comprises a mobile telephone and the user uses the mobile telephone to place a telephone call to the merchant system 120 to conduct a financial transaction. In an example embodiment, the user dials a phone number associated with the merchant system 120 using the user interface 113 of the user device 110.

The merchant system's 120 voice communication device 121 comprises a telephone, computer, smart phone, or other device capable of receiving a telephone call from the user device 110. In an example embodiment, the merchant system's 120 voice communication device 121 comprises a caller identification module 122 that is capable of reading or determining the phone number or other identifier of the user device 110. In an example embodiment, the caller identification module 122 is a part of or a component of the merchant system's 120 voice communication device 120. In another example embodiment, the caller identification module 122 is a separate hardware device that communicates with the merchant system's 120 voice communication device 121.

An example merchant system 120 comprises a merchant device 123. The merchant device 123 may be a personal computer, mobile device (for example, notebook, computer, tablet computer, netbook computer, personal digital assistant (PDA), video game device, GPS locator device, cellular telephone, Smartphone or other mobile device), television, wearable computing devices (for example, watches, rings, or glasses), or other appropriate technology that includes or is coupled to a web server, or other suitable application 125 for interacting with the account management system 130. In an example embodiment, the merchant device 123 is a point of sale (POS) terminal or other device that is capable of processing a purchase transaction initiated by a user, for example, a cash register. In another example embodiment, the merchant device 120 comprises an application 125 or module that is capable of performing the POS functions. The application 125 may be an integrated part of the merchant device 123 or a standalone hardware device (not shown), in accordance with other example embodiments. In yet another example embodiment, the merchant system 120 comprises another standalone hardware device that performs the POS functions.

In an example embodiment, a merchant operating the merchant device 123 determines the telephone number or identifier of the user device 110 and enters the number into the merchant device 123 into an account management system 130 application 125 via the user interface 129. The merchant device 123 communicates the entered information to the account management system 130 via the network 140 to obtain financial account information or other user information to complete a financial transaction with the user.

An example merchant device 123 saves the financial account information or other user information in a data storage unit 127 until the financial transaction is completed. In an example embodiment, the data storage unit 127 can include any local or remote data storage structure accessible to the merchant device 123 suitable for storing information. In an example embodiment, the data storage unit 127 stores encrypted information, such as HTML5 local storage.

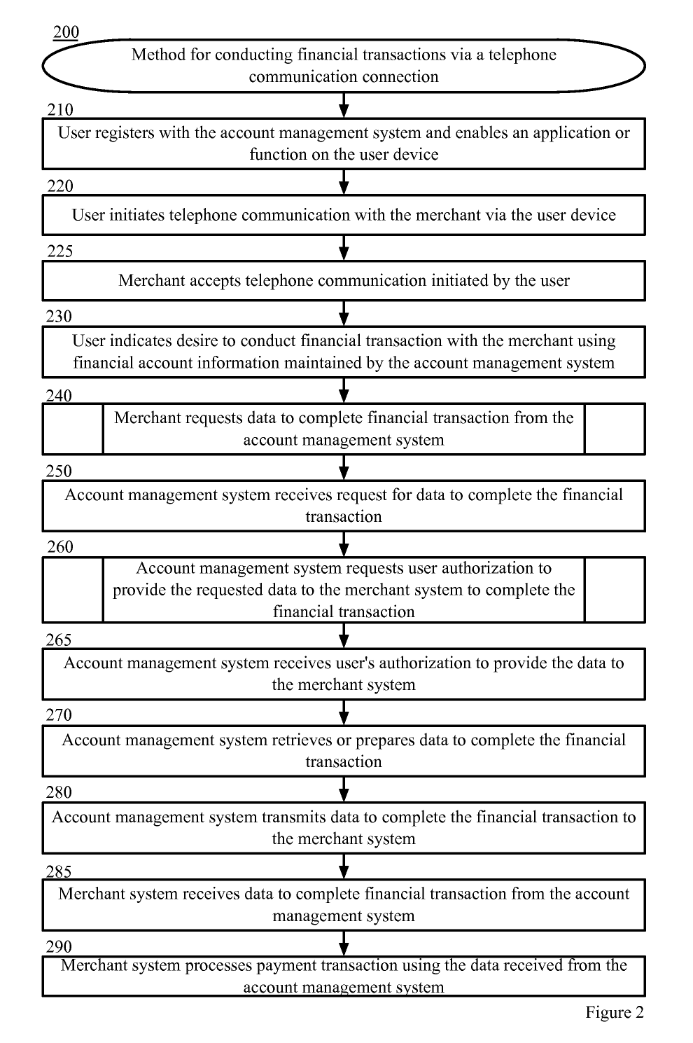

The components of the example operating environment 100 are described hereinafter with reference to the example methods illustrated in FIGS. 2-4. The example methods of FIGS. 2-4 may also be performed with other systems and in other environments.

### Example System Processes

FIG. 2 is a block flow diagram depicting a method 200 for conducting a financial transaction via a telephone connection, in accordance with certain example embodiments. The method 200 is described with reference to the components illustrated in FIG. 1.

In block 210, the user registers with the account management system 130. In an example embodiment, the user installs, downloads, or otherwise enables an account management system 130 program, feature, or application 115 on the user device 110. In an example embodiment, the account management system 130 application 115 comprises a digital wallet application 115. In an example embodiment, the user enables the application 115 on more than one user device 110.

In an example embodiment, the user is prompted to log into, has previously logged, or is otherwise automatically logged into the account management system 130. In another example embodiment, the user's login credentials are shared across other accounts (for example, social networking websites and user device 110 accounts) and the user is automatically logged into the account management system 130 account using the shared login credentials. If the user does not have an account management system 130 account the user is prompted to create an account management system 130 account. In an example embodiment, the user may create the account management system 130 account at any time prior to initiating a financial transaction with a merchant. In an example embodiment, the user accesses the account management system 130 via a website or application 115. In an example embodiment, the user submits registration information to the account management system 130, including, but not limited to, name, address, phone number, e-mail address, and information for one or more registered financial accounts, including bank account debit cards, credit cards, a loyalty rewards account card, or other type of account that can be used to make a purchase (for example, card type, card number, expiration date, security code, and billing address). In an example embodiment, the user's account management system 130 account information is saved in the data storage unit 137 and is accessible to the account management module 133, and account verification module 135. In an example embodiment, the account management system 130 account is a digital wallet account maintained by the account management system 130 or a third party system.

In block 220, the user initiates a telephone communication with the merchant via the user device 110. In an example embodiment, the user dials a telephone number associated with the merchant system's 120 voice communication device 121 using a numerical keypad displayed by the user interface 113 to initiate the telephone communication between the devices (including devices 110 and 120).

In block 225, the merchant accepts the telephone communication initiated by the user. In an example embodiment, the merchant presses a button, user interface element, or other component of the voice communication device 121 to accept the telephone communication. In another example embodiment, the merchant picks up or moves the voice communication device 121 to accept the telephone communication.

In block 230, the user indicates a desire to conduct a financial transaction with the merchant using financial account information maintained in the user's account management system 130 account. In an example embodiment, the user indicates a desire to purchase goods or services from the merchant during the telephone communication.

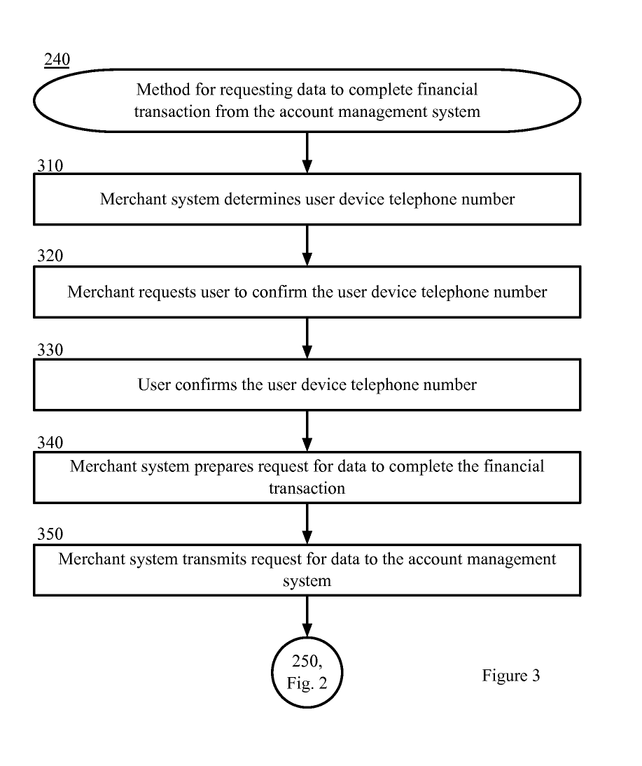

In block 240, the merchant system 120 requests data to complete the financial transaction from the account management system 130. In an example embodiment, the merchant system 120 provides the account management system 130 with the telephone number or other identifier associated with the user and requests financial data to complete the transaction initiated by the user. The method 240 for requesting data to complete a financial transaction from an account management system 130 is described in more detail hereinafter with reference to the methods described in FIG. 3.

FIG. 3 is a block flow diagram depicting a method 240 for requesting data to complete a financial transaction from an account management system 130, in accordance with certain example embodiments, as referenced in block 240. The method 240 is described with reference to the components illustrated in FIG. 1.

In block 310, the merchant system 120 determines the telephone number or other identifier associated with the user device 110. In an example embodiment, the merchant reads the telephone number of the user device 110 from a display on the caller identification module 122 associated with the merchant system's 120 voice communication device 121. In another example embodiment, the merchant device 123 reads or determines the telephone number or other identifier associated with the user device 110 from the caller identification module 122.

In block 320, the merchant requests the user to verify the telephone number or other identifier read from the caller identification module 122. In an example embodiment, the merchant reads the telephone number or other identifier to the user and requests that the user verify the information. In another example embodiment, the merchant requests the user to recite the telephone number or other identifier. In yet another example embodiment, the merchant device 123 transmits a request to the user device 110 for confirmation.

In block 330, the user confirms the telephone number of the user device 110. In an example embodiment, the user provides an affirmative response to the merchant's request for confirmation. In another example embodiment, the user recites the telephone number or other identifier to the merchant. In yet another example embodiment, the user device 110 transmits a response to the merchant device 120.

In block 340, the merchant completes prepares a request for data associated with the telephone number of the user device 110 to complete the financial transaction with the user. In an example embodiment, the merchant types in or keys in the telephone number into an application 125 resident on the merchant device 123 (for example, an account management system 130 application 125). In another example embodiment, the merchant device 123 reads or receives the telephone number from the caller identification module 122 and the merchant presses a button or other user interface object to confirm the telephone number.

In an example embodiment, the request for data comprises a request for financial information to process a payment transaction (for example, financial account information, expiration data, security code, user name, billing address, and/or other financial information). In another example embodiment, the request for data comprises a request for a shipping address, a name of the user, an electronic mail (e-mail) address, facsimile number, and/or other non-financial information. In an example embodiment, the merchant logs onto an account management system 130 application 125 or website and selects the data to be requested. In an example embodiment, the application 125 comprises a wizard or form set-up that guides the merchant through a series of prompts to request certain data. In another example embodiment, the merchant can save the forms so that the same sets of data are requested for each user when a new transaction is initiated.

In block 350, the merchant device 123 transmits the request for data to the account management system 130. In an example embodiment, the merchant presses a button or other user interface object on the merchant device 123 to transmit the completed request for data to the account management system 130.

The method 240 then proceeds to block 250 in FIG. 2.

Returning to FIG. 2, in block 250, the account management system 130 receives the request for data from the merchant device 123.

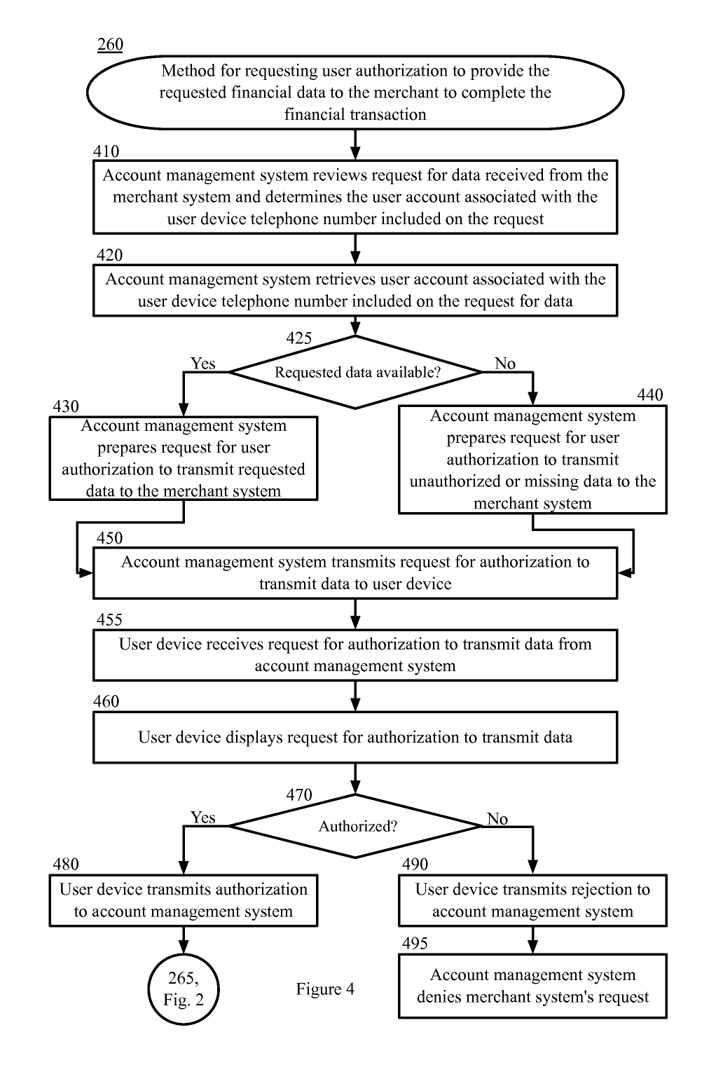

In block 260, the account management system 130 requests user authorization to provide the requested data to the merchant system 120 to complete the financial transaction. In an example embodiment, the account management system 130 transmits a request for authorization to the user device 110. The method 260 for requesting user authorization to provide the requested financial data to the merchant system 120 to complete the financial transaction, in accordance with certain example embodiments is described in more detail hereinafter with reference to the methods described in FIG. 4.

FIG. 4 is a block flow diagram depicting a method 260 for requesting user authorization to provide the requested financial data to the merchant system 120 to complete the financial transaction, in accordance with certain example embodiments, in accordance with certain example embodiments, as referenced in block 260. The method 260 is described with reference to the components illustrated in FIG. 1.

In block 410, the account management system 130 determines which user account is associated with the request. In an example embodiment, the request for data comprises the telephone number or other identifier associated with the user device 110. The account management system 130 reviews the request and identifies the telephone number. In an example embodiment, the account management system 130 determines which user account is associated with the user device 110 telephone number.

In block 420, the account management system 130 retrieves the user account associated with the user device 110 telephone number. In an example embodiment, the account management module 133 of the account management system 130 retrieves the user account from the data storage unit 137.

In block 425, the account management system 130 determines whether the data requested by the merchant system 120 is available in the user account. In an example embodiment, the account management system 130 reviews the user account and cross-references the data requested by the merchant system 120 with the data saved in the user account. For example, if the merchant system 120 requested a financial account number and a mailing address for the user, the account management system 130 determines if the user has both pieces of information saved in the user account. In another example embodiment, the account management system 130 determines if the user has indicated that some data cannot be transmitted or shared.

If the requested data is available, the method 260 proceeds to block 430 in FIG. 4. In block 430, the account management system 130 prepares a request for user authorization to transmit the requested data to the merchant system 110. In an example embodiment, the request for authorization comprises a listing of the information requested by the merchant system 120 in the request for data (for example, Merchant X requested $10, which will be processed using the financial account ending 1234, your name, mailing address, and billing address). In another example embodiment, the request for authorization comprises a notification that the merchant system 120 requested data to process a financial transaction (for example, Merchant X requested $10).

The method 260 then proceeds to block 450.

Returning to block 425, if the requested data is not available, the method 260 proceeds to block 440 in FIG. 4. In block 440, the account management system 130 prepares a request for authorization to transmit missing or unauthorized data to the merchant system 120. In an example embodiment, the user has not provided or authorized the release of a piece of information. For example, the user has not provided or authorized the release of the user's mailing address. However, the merchant system 120 requests the user's mailing address so that goods purchased can be shipped to the user. In the request for authorization, the account management system 130 requests that the user provide the missing information and/or requests confirmation that the account management system 130 can provide the information to the merchant system 120.

In another example embodiment, the request for data received from the merchant system 120 comprises a request for optional data (for example, an electronic message (e-mail) address or loyalty account information). If the user has not provided this information to the account management system 130, the request for authorization will provide the user the opportunity to provide the data or decline to provide the data. In the event that the user declines to provide the data, the financial transaction may still be completed based on an authorization for the transmission of the required data.

In block 450, the account management system 130 transmits the request for authorization to transmit the data to the user device 110. In an example embodiment, the request is transmitted via the network 140.

In an example embodiment, the request for authorization is transmitted to the user device 110 associated with the telephone number or other identifier received in the request for data from the merchant system 120. In another example embodiment, more than one user device 110 is associated with the telephone number or other identifier. In this embodiment, the request for authorization is transmitted to each user device 110 associated with the telephone number or identifier. In another example embodiment, the account management system 130 determines which user device 110 is in use or in communication with the merchant system 120 voice communication device 121 and transmits the request for authorization to the determined user device 110. In an example embodiment, the account management system 130 is capable of communicating with or reading the operating system, voice communication module 111, or other module on each user device 110 to determine which user device is in operation or in communication with the merchant system's 120 voice communication device 121.

In block 455, the user device 110 receives the request for authorization to transmit data from the account management system 130. In an example embodiment, receipt of the request prompts the user device 110 to activate or open an account management system 130 or digital wallet application 115 on the user device 110.

In block 460, the user device 110 displays the request for authorization to transmits the data. In an example embodiment, the request is displayed by the application 115 on the user interface 113 so that the user can read it. In an example embodiment, the display comprises a button or user interface object that allows the user to authorize the request. In another example embodiment, the displayed comprises one or more fields that allow the user to provide any additional data requested by the merchant system 110.

In block 470, the user authorizes or denies the request for authorization.

If the request for authorization is denied, the method 260 proceeds to block 490 in FIG. 4. In block 490, the user device 110 transmits a denial of the request to the account management system 130. In an example embodiment, the request for authorization is denied when the user presses a button or other user interface object displayed by the user device 110 to affirm the user's desire not to proceed with the financial transaction.

In block 495, the account management system 130 receives the notice denying the authorization request from the user device 110 and denies the merchant system's 120 request for data.

Returning to block 470 in FIG. 4, if the request for authorization is authorized, the method 260 proceeds to block 480 in FIG. 4. In block 480, the user device 110 transmits an authorization of the request for authorization to the account management system 130. In an example embodiment, the request is authorized when the user presses a button or other user interface object displayed by the user device 110 to affirm the user's desire to proceed with the financial transaction.

The method 260 then proceeds to block 265 in FIG. 2.

Returning to block 265, the account management system 130 receives the user's authorization to provide the requested data to the merchant system 120. In an example embodiment, the user's authorization comprises one or more fields of additional data to be provided to the merchant system 120.

In block 270, the account management system 130 retrieves or prepares the data required or requested to complete the financial transaction. In an example embodiment, the account management system 130 saves the one or more fields of additional data provided by the user in the user's account management system 130 account. In an example embodiment, the account management system 130 fills in fields of or lists the requested data in a response to the request for data.

In another example embodiment, the account management system 130 generates a single use or limited use financial account information to provide in response to the request for data. In this example, the user's actual financial account information is not provided to the merchant system. The generated financial account information comprises one or more of a financial card account number that resembles a credit card or debit card number, an expiration date that resembles an expiration date for a credit card or debit card, a security code that resembles a card verification code for a credit card or debit card, and an authorized spending limit up to the payment amount. In another example embodiment, the account management system 130 generates a payment code, for example a QR or other machine-readable code, with the financial account information embedded in the code. In an example embodiment, the generated financial account information is limited to use by the merchant system 120 requesting the data. In another example embodiment, the generated financial account information is limited in time so that it is only valid for a pre-determined period of time. In another example embodiment, the generated financial account information is limited in amount so that a transaction is only approved up to a pre-determined amount.

In block 280, the account management system 130 transmits the data to the merchant system 120. In an example embodiment, the data is transmitted to the merchant device 123 via the network 140.

In block 285, the merchant system 120 receives the data from the account management system 130.

In block 290, the merchant system 120 processes a payment transaction using the data received from the account management system 130. In an example embodiment, the application 125 displays the data so that the merchant can enter the data in a POS terminal to process the payment transaction. In another example embodiment, the application 125 is a payment processing application that is capable of processing the payment transaction.

In an example embodiment, the methods described herein are performed at least in part during the telephone communication between the merchant and user.

### Other Example Embodiments

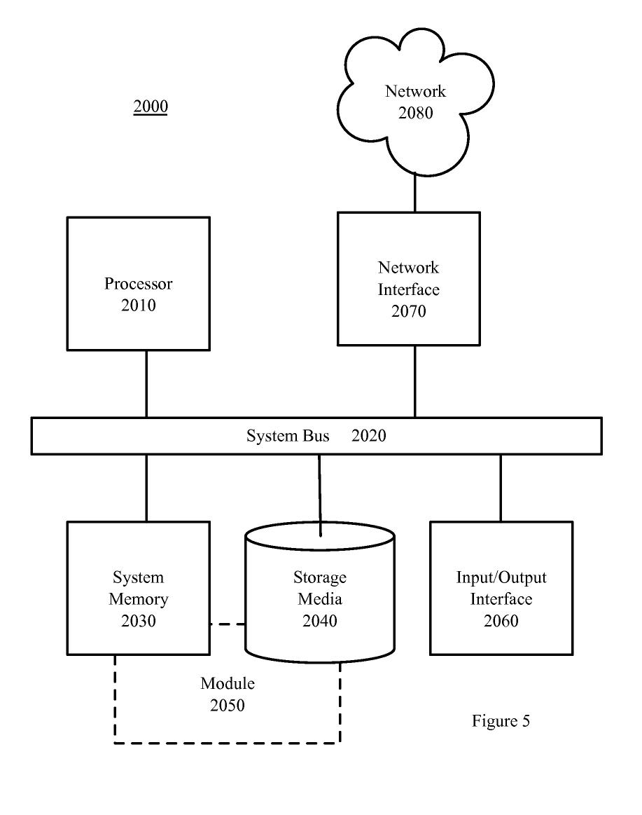

FIG. 5 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (DSP), an application specific integrated circuit (ASIC), a graphics processing unit (GPU), a field programmable gate array (FPGA), a programmable logic device (PLD), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (ROM), programmable read-only memory (PROM), erasable programmable read-only memory (EPROM), flash memory, or any other device capable of storing program instructions or data with or without applied power. The system memory 2030 may also include volatile memories such as random access memory (RAM), static random access memory (SRAM), dynamic random access memory (DRAM), and synchronous dynamic random access memory (SDRAM). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (CD-ROM), a digital versatile disc (DVD), a Blu-ray disc, a magnetic tape, a flash memory, other non-volatile memory device, a solid state drive (SSD), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (I/O) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (SCSI), serial-attached SCSI (SAS), fiber channel, peripheral component interconnect (PCI), PCI express (PCIe), serial bus, parallel bus, advanced technology attached (ATA), serial ATA (SATA), universal serial bus (USB), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (SOC), system on package (SOP), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the scope of the following claims, which are to be accorded the broadest interpretation so as to encompass such alternate embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method for completing financial transactions by telephone, comprising:
receiving, by one or more computing devices operated by an account management system and from one or more computing devices operated by a merchant, a request for user data to complete a financial transaction between a user and the merchant, the request for user data comprising a telephone identification number associated with a telephone operated by the user when the user indicated a desire to complete the financial transaction with the merchant;
determining, by the one or more computing devices, a user account associated with the telephone identification number;
reviewing, by the one or more computing devices, the user account associated with the telephone identification number to determine whether the user provided all data requested by the merchant in the request for user data;
transmitting, by the one or more computing devices and to a computing device operated by the user, a request for authorization to transmit the user data to the merchant;
receiving, by the one or more computing devices and from the computing device operated by the user, authorization to transmit the user data to the merchant; and
transmitting, by the one or more computing devices and to the one or more computing device operated by the merchant, the user data to complete the financial transaction between the user and the merchant.

2. The method of claim 1, wherein the computing device operated by the user comprises the telephone operated by the user when the user indicated a desire to complete the financial transaction with the merchant.

3. The method of claim 1, wherein the computing device operated by the user comprises a default computing device designated by the user.

4. The method of claim 1, further comprising determining, by the one or more computing devices, an identification of the computing device operated by the user.

5. The method of claim 4, wherein determining the identification of the computing device operated by the user comprises determining, by the one or more computing devices, which of two or more computing devices is making a telephone call at a time when the request for user data to complete the financial transaction was received.

6. The method of claim 1, further comprising determining, by the one or more computing devices, that the user did not provide all the data requested by the merchant in the request for data, wherein the request for authorization to transmit the user data to the merchant comprises a request for missing data requested by the merchant.

7. The method of claim 6, wherein the authorization to transmit the user data to the merchant received by the one or more computing devices comprises the missing data.

8. The method of claim 1, wherein the computing device operated by the user displays the request for authorization to transmit the user data to the merchant received from the one or more computing device and the user initiates a function on the computing device to provide the authorization.

9. The method of claim 1, wherein the user data comprises one or more of financial account information, a name of the user, a mailing address of the user, and a billing address of the user.

10. The method of claim 1, further comprising creating, by the one or more computing devices, financial account information to complete the financial transaction between the user and the merchant, wherein the user data comprises the created financial account information.

11. The method of claim 11, wherein the created financial account information comprises information associated with a financial account that is limited to a payment for a requested transaction amount, a payment with a requested merchant, or a payment during a predetermined period of time.

12. A computer program product, comprising:
a non-transitory computer-readable medium having computer-readable program instructions embodied therein that when executed by a computer cause the computer to complete financial transactions by telephone, the computer-readable program instructions comprising:
computer-readable program instructions to receive, from one or more computing devices operated by a merchant, a request for user data to complete a financial transaction between a user and the merchant, the request for user data comprising a telephone identification number associated with a telephone operated by the user when the user indicated a desire to complete the financial transaction with the merchant;
computer-readable program instructions to determine a user account associated with the telephone identification number;
computer-readable program instructions to review the user account associated with the telephone identification number to determine that the user provided all data requested by the merchant in the request for user data;
computer-readable program instructions to transmit, to a computing device operated by the user, a request for authorization to transmit the user data to the merchant;
computer-readable program instructions to receive, from the computing device operated by the user, authorization to transmit the user data to the merchant; and
computer-readable program instructions to transmit, to the one or more computing device operated by the merchant, the user data to complete the financial transaction between the user and the merchant.

13. The computer program product of claim 12, wherein the computing device operated by the user comprises the telephone operated by the user when the user indicated a desire to complete the financial transaction with the merchant.

14. The computer program product of claim 12, wherein the computing device operated by the user comprises a default computing device designated by the user.

15. The computer program product of claim 12, further comprising computer-readable program instructions to determine an identification of the computing device operated by the user.

16. The computer program product of claim 15, wherein determining the identification of the computing device operated by the user comprises computer-readable program instructions to determine which of two or more computing devices is making a telephone call at a time when the request for user data to complete the financial transaction was received.

17. A system for completing financial transactions by telephone, the system comprising:
a storage device; and
a processor communicatively coupled to the storage device, wherein the processor executes application code instructions that are stored in the storage device and that cause the system to:
receive, from one or more computing devices operated by a merchant, a request for user data to complete a financial transaction between a user and the merchant, the request for user data comprising a telephone identification number associated with a telephone operated by the user when the user indicated a desire to complete the financial transaction with the merchant;
determine a user account associated with the telephone identification number;
review the user account associated with the telephone identification number to determine that the user provided all data requested by the merchant in the request for user data;
transmit, to a computing device operated by the user, a request for authorization to transmit the user data to the merchant;
receive, from the computing device operated by the user, authorization to transmit the user data to the merchant; and
transmit, to the one or more computing device operated by the merchant, the user data to complete the financial transaction between the user and the merchant.

18. The system of claim 17, wherein the computing device operated by the user comprises the telephone operated by the user when the user indicated a desire to complete the financial transaction with the merchant.

19. The system of claim 17, wherein the computing device operated by the user comprises a default computing device designated by the user.

20. The system of claim 17, wherein the processor is further configured to execute computer-executable instructions stored in the storage device to cause the system to determine an identification of the computing device operated by the user.

21. The system of claim 20, wherein determining the identification of the computing device operated by the user comprises determining which of two or more computing devices is making a telephone call at a time when the request for user data to complete the financial transaction was received.
